(19) United States
(12) Patent Application Publication
(10) Pub. No.: US 2007/0005251 A1
(43) Pub. Date: Jan. 4, 2007

(54) Density log without a nuclear source

(75) Inventors: Roland E. Chemali, Kingwood, TX (US); Luc G. Van Puymbroeck, Humble, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated, Houston, TX (US)

(21) Appl. No.: 11/447,780

(22) Filed: Jun. 6, 2006

Related U.S. Application Data
(60) Provisional application No. 60/692,749, filed on Jun. 22, 2005.

(51) Int. Cl. G01V 1/40

(52) U.S. Cl. 702/6

(57) ABSTRACT

An acoustic transducer on a downhole tool sends an acoustic wave through a sensor plate. The signal is reflected by the borehole wall back towards the transducer. The received signal is responsive to the formation impedance.

### CROSS-REFERENCES TO RELATED APPLICATIONS

This application claims priority from U.S. Provisional Patent Application Ser. No. 60/692,749 filed on 22 Jun. 2005.

### BACKGROUND OF THE INVENTION

1. Field of the Invention

This invention relates generally to borehole logging apparatus and methods for performing density logging measurements without using any type of radioactive sources nor radiations. In particular, this invention relates to a new and improved apparatus for effecting formation density logging in real time without using gamma rays in a measurement-while-drilling (MWD) tool, slickline too, pipe-conveyed tool, or wireline tool. Specifically, the invention is directed towards the use of acoustic measurements for determination of the density of earth formations.

2. Description of the Related Art

Oil well logging has been known for many years and provides an oil and gas well driller with information about the earth formations being drilled. In conventional oil well logging, after a well has been drilled, a probe known as a sonde is lowered into the borehole and used to determine some characteristic of the formations which the well has traversed. The probe is typically a hermetically sealed steel cylinder which hangs at the end of a long cable which gives mechanical support to the sonde and provides power to the instrumentation inside the sonde. The cable also provides communication channels for sending information up to the surface. It thus becomes possible to measure some parameter of the earth's formations as a function of depth, that is, while the sonde is being pulled uphole.

A wireline sonde usually transmits energy into the formation as well as a suitable receiver for detecting the same energy returning from the formation. These could include resistivity, acoustic, or nuclear measurements. Nuclear measurements are particularly useful in the determination of density of earth formations. Wireline gamma ray density probes are well known and comprise devices incorporating a gamma ray source and a gamma ray detector, shielded from each other to prevent counting of radiation emitted directly from the source. During operation of the probe, gamma rays (or photons) emitted from the source enter the formation to be studied, and interact with the atomic electrons of the material of the formation by photoelectric absorption, by Compton scattering, or by pair production. In photoelectric absorption and pair production phenomena, the particular photons involved in the interacting are removed from the gamma ray beam.

Examples of prior art wireline density devices are disclosed in U.S. Pat. Nos. 3,202,822, 3,321,625, 3,846,631, 3,858,037, 3,864,569 and 4,628,202. Wireline formation evaluation tools such as the aforementioned gamma ray density tools have many drawbacks and disadvantages including loss of drilling time, the expense and delay involved in tripping the drillstring so as to enable the wireline to be lowered into the borehole and both the build up of a substantial mud cake and invasion of the formation by the drilling fluids during the time period between drilling and taking measurements. An improvement over these prior art techniques is the art of measurement-while-drilling (MWD) in which many of the characteristics of the formation are determined during the drilling of the borehole. Examples of MWD apparatus and methods for density determination are found, for example in U.S. Pat. No. 5,397,893 to Minette and U.S. Pat. No. 6,584,837 to Kurkoski.

One potential problem with MWD logging tools is the issue of safety—the use of nuclear radiation in the harsh drilling environment that the measurements are typically made while the tool is rotating. In addition, nuclear measurements are particularly degraded by large standoffs due to the scattering produced by borehole fluids between the tool and the formation.

Acoustic measurements have been used for determination of an acoustic image of borehole walls. U.S. Pat. No. 4,463,378 to Rambow discloses a display system for use with a well logging tool of the type that scans a borehole wall by rotating an acoustical transducer while emitting and receiving acoustic energy. The received acoustic or information signals are received and recorded for later use. In addition, both the amplitude and time-of-flight of the information signals are digitized and passed to a computer that controls a television display and cathode ray tube. U.S. Pat. No. 5,987,385 to Varsamis et al. discloses an acoustic logging tool useful for creating an image of a borehole while drilling. The reflected acoustic signals from a borehole wall are responsive to the formation density contrast. However, borehole acoustic techniques have not addressed the problem of determination of formation bulk density.

There is a need for a method and apparatus for determining formation density without the use of nuclear sensors. The present invention satisfies that need.

### SUMMARY OF THE INVENTION

The present invention is an acoustic apparatus for determination of the density of earth formations. At least one transducer on a downhole tool generates an acoustic wave that propagates through a sensor plate to the borehole wall. The transducer produces a signal responsive to a reflection of the acoustic wave from the wall of the borehole. A processor estimates the acoustic impedance of the earth formation from the signal. The processor may remove reverberations within the sensor plate, and/or reverberations within the annulus between the plate and the borehole wall. The processor may then determine the density from the impedance using either a predetermined relationship between density and velocity or from a separate measurement of velocity. When combined with orientation measurements, a density image may be produced by the processor.

Another embodiment of the invention is a method of determining the density of earth formations. An acoustic pulse is generated that propagates through a sensor plate and is reflected from the borehole wall. A signal received by a receiver in the sensor is dereverberated to determine the formation impedance. The dereverberation uses the thickness of the sensor plate and the acoustic velocity within the plate.

### BRIEF DESCRIPTION OF THE DRAWINGS

The present invention is best understood with reference to the accompanying figures in which like numerals refer to like elements and in which:

FIG. 1 (Prior Art) shows a measurement-while-drilling tool suitable for use with the present invention;

FIG. 2 is a cross sectional view of a measurement sub of the present invention;

FIG. 3 illustrates exemplary ray-paths from the sensor arrangement of FIG. 2;

FIG. 4 shows the reflectivity sequence corresponding to the arrangement of FIG. 2;

FIG. 5 shows an exemplary waveform corresponding to the arrangement of FIG. 2; and

FIGS. 6a-6d (prior art) show waveforms and associated spectra for different borehole conditions.

### DETAILED DESCRIPTION OF THE INVENTION

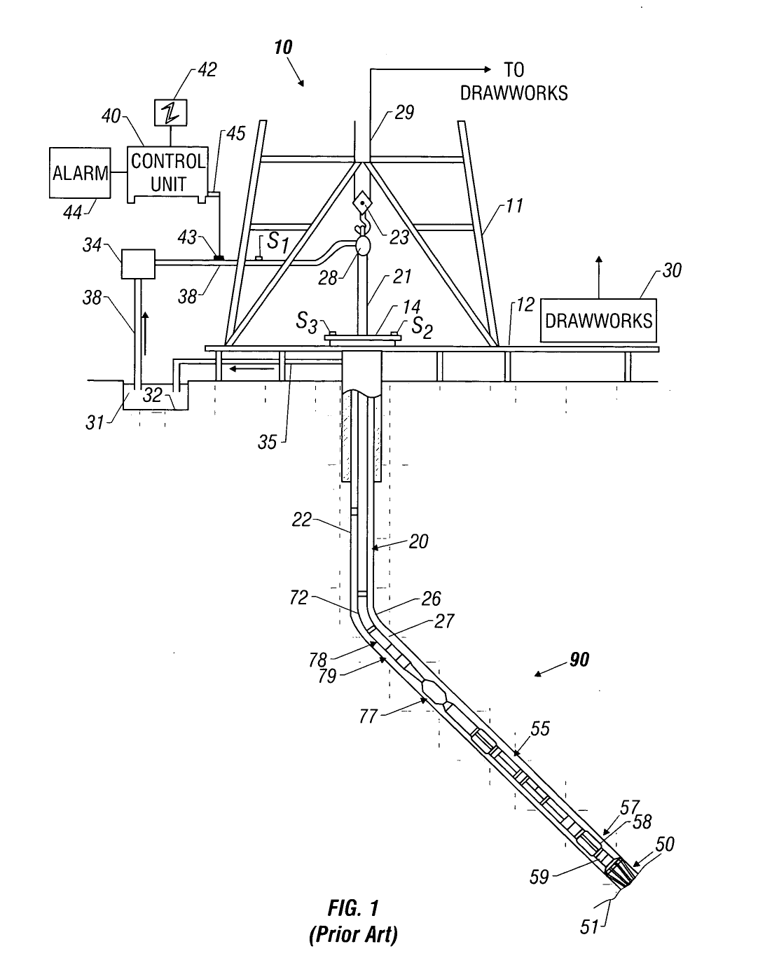

FIG. 1 shows a schematic diagram of a drilling system 10 with a drillstring 20 carrying a drilling assembly 90 (also referred to as the bottom-hole assembly, or “BHA”) conveyed in a “wellbore” or “borehole” 26 for drilling the wellbore. The drilling system 10 includes a conventional derrick 11 erected on a floor 12 which supports a rotary table 14 that is rotated by a prime mover such as an electric motor (not shown) at a desired rotational speed. The drillstring 20 includes a tubing such as a drill pipe 22 or a coiled-tubing extending downward from the surface into the borehole 26. The drillstring 20 is pushed into the wellbore 26 when a drill pipe 22 is used as the tubing. For coiled-tubing applications, a tubing injector, such as an injector (not shown), however, is used to move the tubing from a source thereof, such as a reel (not shown), to the wellbore 26. The drill bit 50 attached to the end of the drillstring breaks up the geological formations when it is rotated to drill the borehole 26. If a drill pipe 22 is used, the drillstring 20 is coupled to a drawworks 30 via a Kelly joint 21, swivel 28, and line 29 through a pulley 23. During drilling operations, the drawworks 30 is operated to control the weight on bit, which is an important parameter that affects the rate of penetration. The operation of the drawworks is well known in the art and is thus not described in detail herein.

During drilling operations, a suitable drilling fluid 31 from a mud pit (source) 32 is circulated under pressure through a channel in the drillstring 20 by a mud pump 34. The drilling fluid passes from the mud pump 34 into the drillstring 20 via a desurger (not shown), fluid line 38 and Kelly joint 21. The drilling fluid 31 is discharged at the borehole bottom 51 through an opening in the drill bit 50. The drilling fluid 31 circulates uphole through the annular space 27 between the drillstring 20 and the borehole 26 and returns to the mud pit 32 via a return line 35. The drilling fluid acts to lubricate the drill bit 50 and to carry borehole cutting or chips away from the drill bit 50. A sensor S₁ typically placed in the line 38 provides information about the fluid flow rate. A surface torque sensor S₂ and a sensor S₃ associated with the drillstring 20 respectively provide information about the torque and rotational speed of the drillstring. Additionally, a sensor (not shown) associated with line 29 is used to provide the hook load of the drillstring 20.

In one embodiment of the invention, the drill bit 50 is rotated by only rotating the drill pipe 22. In another embodiment of the invention, a downhole motor 55 (mud motor) is disposed in the drilling assembly 90 to rotate the drill bit 50 and the drill pipe 22 is rotated usually to supplement the rotational power, if required, and to effect changes in the drilling direction.

In an exemplary embodiment of FIG. 1, the mud motor 55 is coupled to the drill bit 50 via a drive shaft (not shown) disposed in a bearing assembly 57. The mud motor rotates the drill bit 50 when the drilling fluid 31 passes through the mud motor 55 under pressure. The bearing assembly 57 supports the radial and axial forces of the drill bit. A stabilizer 58 coupled to the bearing assembly 57 acts as a centralizer for the lowermost portion of the mud motor assembly.

In one embodiment of the invention, a drilling sensor module 59 is placed near the drill bit 50. The drilling sensor module contains sensors, circuitry and processing software and algorithms relating to the dynamic drilling parameters. Such parameters typically include bit bounce, stick-slip of the drilling assembly, backward rotation, torque, shocks, borehole and annulus pressure, acceleration measurements and other measurements of the drill bit condition. A suitable telemetry or communication sub 72 using, for example, two-way telemetry, is also provided as illustrated in the drilling assembly 90. The drilling sensor module processes the sensor information and transmits it to the surface control unit 40 via the telemetry system 72.

The communication sub 72, a power unit 78 and an MWD tool 79 are all connected in tandem with the drillstring 20. Flex subs, for example, are used in connecting the MWD tool 79 in the drilling assembly 90. Such subs and tools form the bottom hole drilling assembly 90 between the drillstring 20 and the drill bit 50. The drilling assembly 90 makes various measurements including the pulsed nuclear magnetic resonance measurements while the borehole 26 is being drilled. The communication sub 72 obtains the signals and measurements and transfers the signals, using two-way telemetry, for example, to be processed on the surface. Alternatively, the signals can be processed using a downhole processor in the drilling assembly 90.

The surface control unit or processor 40 also receives signals from other downhole sensors and devices and signals from sensors S₁-S₃ and other sensors used in the system 10 and processes such signals according to programmed instructions provided to the surface control unit 40. The surface control unit 40 displays desired drilling parameters and other information on a display/monitor 42 utilized by an operator to control the drilling operations. The surface control unit 40 typically includes a computer or a microprocessor-based processing system, memory for storing programs or models and data, a recorder for recording data, and other peripherals. The control unit 40 is typically adapted to activate alarms 44 when certain unsafe or undesirable operating conditions occur.

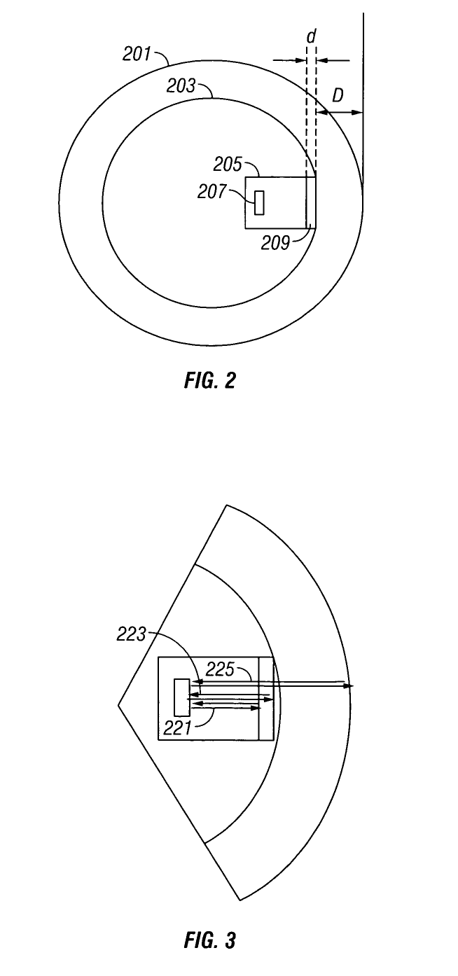

Turning now to FIG. 2, a cross-section of an acoustic sub that can be used for determining the formation density is illustrated. The drill collar is denoted by 203 and the borehole wall by 201. An acoustic transducer 207 is positioned inside a cavity 205. One end of the cavity has a metal plate 209 with known thickness, compressional wave velocity and density. The cavity is filled with a fluid with known density and compressional wave velocity.

FIG. 3 shows raypaths for exemplary wave propagation resulting from excitation of the transducer. The pair 221 is the raypath corresponding to an acoustic wave generated by the transducer, reflected by the inner wall of the plate 209 and returning to the transducer. The pair 223 is the raypath corresponding to an acoustic wave generated by the transmitter, reflected by the outer wall of the plate 209 and returning to the transducer. The raypath 225 is for a ray that is reflected from the borehole wall. In one embodiment of the invention, the same transducer acts as both a transmitter and a receiver. In another embodiment of the invention, a first transducer is used to generate the acoustic wave and a second transducer acts as a receiver and generates a signal response to the acoustic impedance of the formation. This manner in which this is done is discussed next.

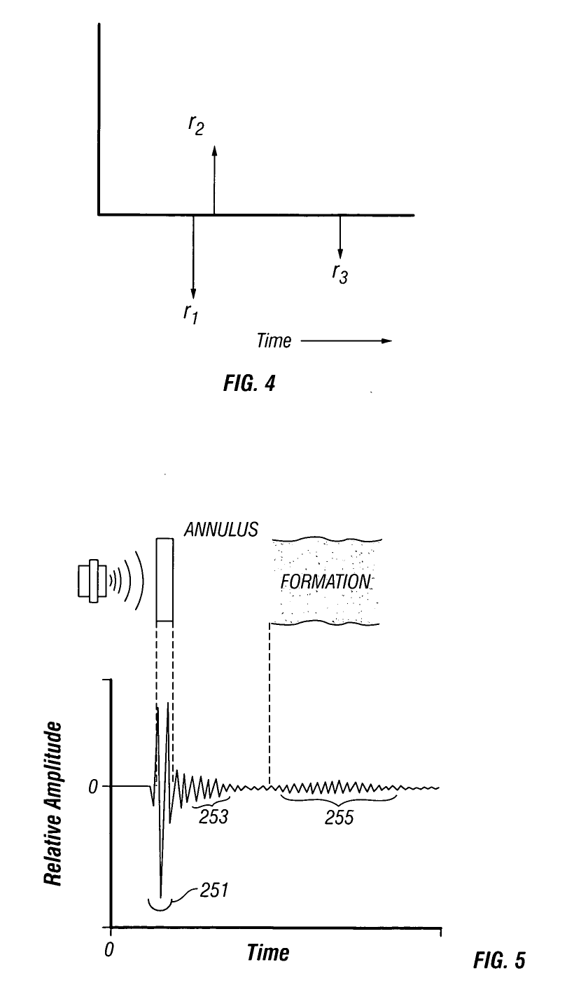

The response at the transducer may be denoted by the reflectivity sequence shown in FIG. 4. Denoting by vᵢ, i=1, 2, 3, 4 as the compressional velocity in the cavity, the plate, the annulus and the formation, and ρᵢ as the corresponding densities, the acoustic impedances of the different zones are given by
Zᵢ=ρvᵢ (1).

The reflectivities rᵢ in FIG. 4 are given by

$${r}_{i} = \frac{{Z}_{i} - {Z}_{i + 1}}{{Z}_{i} + {Z}_{i + 1}} . \qquad ( 2 )$$

The time delay Δt₁ between r₁ and r₂ is given by d/v₁ while the time delay Δt₂ between r₂ and r₃ is given by D/v₂.

The received signal has the general character depicted in FIG. 5. The reflections from the front and back of the plate are depicted by 251. Typically, the delay Δt₁ is less than the dominant period of the acoustic wave generated by the transducer, so that the reflections from the front and back are not easy to separate. The effect of this small separation is to produce a ringing signal within the plate, generally denoted by 253. The reflection from the borehole wall 255 also includes the effects of the reverberation. The reflection from the borehole wall is indicative of the acoustic impedance of the formation. The problem is to estimate, from the received signal, the acoustic properties of the formation.

A similar problem has been solved for cement bond logging and is discussed in Havira, the time sequence of the reflected wave when the plate is bounded on either side by semi-infinite layers is:
R(jω)=r₁+(1+r₁)r₂(1−r₁)e^{-jωT}+(1+r₁)r₂r₁r₂(1−r₁)e^{-2jωT}+ (3)

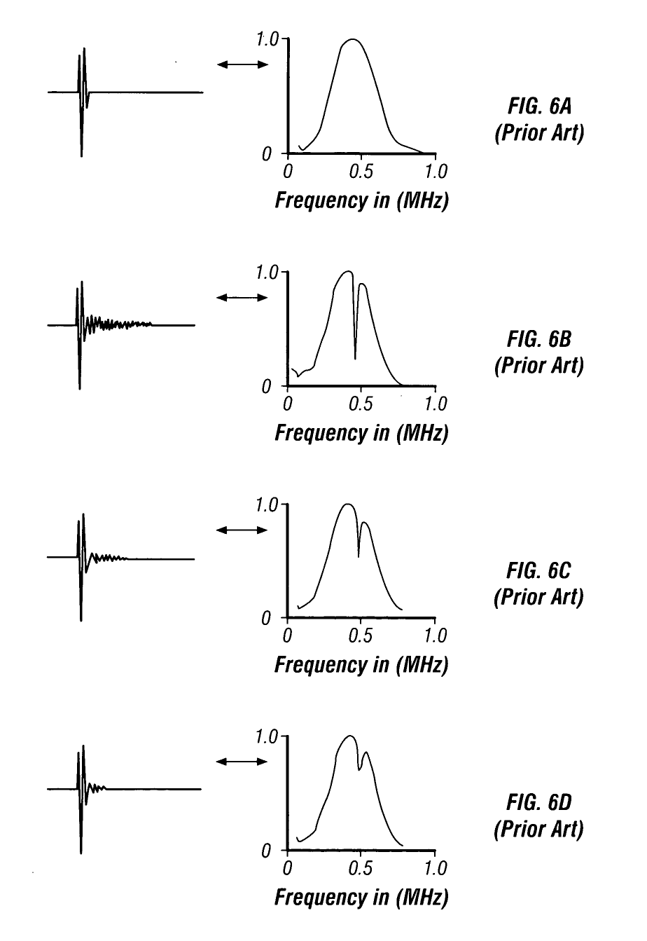

A qualitative picture of the results is shown in FIGS. 6a-6d. Shown in FIG. 6a is the time domain signal and its frequency domain representation of the signal generated by the transducer. This is what would be observed if the material on the outside of the plate had the same impedance as the plate (no reflection from the outside of the plate). FIG. 6b shows signals that would be obtained if the annulus were extremely large and there were no reflections from the borehole wall. The deep notch in the spectral representation results from the fact that the reflection coefficients at the inside and outside of the plate are very large and of opposite sign. FIG. 6d corresponds to the case where there is no annulus—there is still a notch in the frequency spectrum due to the fact that the reflectivity at the inside is larger than that at the outside. FIG. 6c is for a relatively small annulus. Qualitatively, it can be seen that the depth of the notch is an indication of an effective impedance mismatch between the plate and whatever is on the outside of the plate (formation or annulus-formation combination) and thus serves as an indicator of the formation impedance. It is also seen that the ringing in the time domain is the least in FIG. 6d, which corresponds to the smallest mismatch while FIG. 6b shows the greatest amount of ringing for the largest mismatch in impedance. The ringing is quantifiable by Q, the quality factor of the plate.

The problem encountered here is similar to the dereverberation and deconvolution problem encountered in seismic data processing. We discuss the dereverberation issue first. For the case where the annulus is sufficiently large, so that the reflection from the borehole wall is distinctly separate from the reflection from the plate, a simple dereverberation filter discussed in Backus can be used to remove the effects of the plate reverberation. The Backus filter is given by:
H(ω)=(1+r₂e^{-jωΔt})² (4).
This is valid for the case where the reflectivity of the inside is −1. Modification for the case where r₁ is not equal to unity is straightforward. In general, the dereverberation filter depends on the thickness of the plate, the acoustic velocity of the plate, the density of the plate, the density of the fluid in a cavity on the logging tool, the acoustic velocity of a fluid in a cavity on the logging tool, the density of a fluid in the annulus between the logging tool and the borehole wall, and the acoustic velocity of a fluid in an annulus between the logging tool and the borehole wall. All of these parameters have the common property that they determine the acoustic impedance of the corresponding medium and thus affect the propagation and reflection of the acoustic wave.

The density and compressional velocities of the fluid in the cavity and of the plate are quantities that are measurable under laboratory conditions. Temperature correction may be necessary for the fluid properties. The thickness of the plate is a known quantity so that Δt₁ is also a known quantity. Determination of r₂ requires knowledge of the borehole mud density and velocity. The former can be determined either from surface measurements and applying a temperature correction, or from downhole measurements. The acoustic velocity of the borehole fluid can be determined using, for example, apparatus disclosed in U.S. patent application Ser. No. 10/298,706 of Hassan et al, having the same assignee as the present invention and the contents of which are incorporated herein by reference. Eqn. (4) thus defines a dereverberation filter that can be applied to the received signal. The signal after dereverberation would enable the reflection coefficients at the boundaries to be determined.

For the case where the annulus is small, reverberations may also be generated therein. In one embodiment of the present invention, a second dereverberation operation is applied to remove the effects of reverberations within the annulus. One of the parameters needed is the transit time of an acoustic signal through the annulus. This is readily determined from standard caliper measurements (acoustic or mechanical caliper). The dereverberation operation can then be determined by searching for the reflectivity parameter in eqn. (3) that minimizes the energy in the dereverberated signal. This reflectivity parameter together with knowledge of the mud impedance readily gives the acoustic impedance of the formation.

Instead of sequential dereverberation operations, it is also possible to use a somewhat more complicated model than that used by Backus. Such an approach is discussed in Middleton et al., and is based on the use of multiple layers that produce reverberations. The two layer reverberation operator takes the form:

$$R ( j ω ) = \frac{1 + \frac{{α}_{2}}{{α}_{1}} {ⅇ}^{- ⅈω ( {τ}_{2} - {τ}_{1} )}}{1 - {α}_{1} {ⅇ}^{- {ⅈωτ}_{1}} - {α}_{2} {ⅇ}^{- {ⅈωτ}_{2}} + {α}_{12} {ⅇ}^{- ⅈω ( {τ}_{2} - {τ}_{1} )}} . \qquad ( 4 )$$

In one embodiment of the invention, in addition to the dereverberation, an additional deconvolution operation is also carried out. The deconvolution is a deterministic deconvolution that uses an inverse filter derived from the known waveform of the acoustic wave generated by the transmitter. Such deconvolution methods are well known in the art and are not discussed further. The deconvolution may be carried out prior to or after the dereverberation.

In one embodiment of the invention, the formation density and acoustic velocity are determined along with the impedance. For wireline applications, a method and apparatus such as that described in U.S. Pat. No. 6,477,112 to Tang et al. may be used to determine the velocity. Knowing the impedance and the velocity, the density is readily determined. In an alternate embodiment of the invention, use is made of an empirical relation between density and velocity. The same relation may be used for a number of different lithologies. Alternatively, a different empirical relation may be used for different lithologies. The lithology-dependent relation requires knowledge of the formation lithology, something that is readily determinable from other logs. A specific example of such a relation is given by Gardner et al. as:
ρ=0.23Vₚ^{0.25} (5)
where Vₚ is the formation P-wave velocity in ft/s and ρ is the density in gm/cc. The formation impedance determined above is the product of the formation density and formation acoustic velocity. Hence by using the empirical relationship, the density and/or velocity can be estimated from the impedance.

The choice of operating frequencies for the tool and the selection of materials for the plate are inter-related and can be combined to extend the range of applicability of the acoustic measurements. The depth of the notch in FIGS. 6a-6d is dependent upon the impedance mismatch between the plate, the fluid and the formation. The frequency should be selected so that the notch falls within the spectral bandwidth of the generated acoustic signal. In one embodiment of the invention, the plate is selected of a material that has an impedance close to the average impedance of the formation. With such a material, sensitivity to impedance mismatches is improved.

In one embodiment of the invention, an orientation sensor is used to measure the angular orientation of the plate and the acoustic beam produced by the sensor. This feature may be used in combination with depth measurements to produce data that can be used for density imaging of the borehole wall. The orientation sensor may be a magnetometer. Depth measurements for MWD applications may be made using, for example, the method disclosed in U.S. Pat. No. 6,769,498 to Dubinsky et al., the contents of which are incorporated here by reference. For wireline applications, the method disclosed in U.S. patent application Ser. No. 10/926,810 of Edwards, the contents of which are incorporated herein by reference, may be used.

The processing of the data may be accomplished by a downhole processor. Alternatively, measurements may be stored on a suitable memory device and processed upon retrieval of the memory device. Implicit in the control and processing of the data is the use of a computer program on a suitable machine readable medium that enables the processor to perform the control and processing. The machine readable medium may include ROMs, EPROMs, EAROMs, Flash Memories and Optical disks. All of these media have the capability of storing the data acquired by the logging tool and of storing the instructions for processing the data. It would be apparent to those versed in the art that due to the amount of data being acquired and processed, it is impossible to do the processing and analysis without use of an electronic processor or computer.

The invention has been described with an example of a MWD tool. The method is equally applicable to wireline applications in which the tool is conveyed into the borehole on a wireline. For wireline applications, the tool is typically part of a downhole string of logging instruments. The invention may also be practiced with instruments conveyed on coiled tubing. All or part of the processing may be done at the surface or at a remote location.

While the foregoing disclosure is directed to the specific embodiments of the invention, various modifications will be apparent to those skilled in the art. It is intended that all such variations within the scope of the appended claims be embraced by the foregoing disclosure.

What is claimed is:

1. An apparatus for determining a property of an earth formation, the apparatus comprising:
(a) a logging tool conveyed in a borehole in the earth formation;
(b) at least one transducer on the logging tool which:
(A) generates an acoustic wave which propagates through a plate on the logging tool to a wall of the borehole; and
(B) produces a signal responsive to a reflection of the acoustic wave from the wall of the borehole; and
(c) a processor which estimates from the signal a property related to an acoustic impedance of the formation.

2. The apparatus of claim 1 wherein the at least one transducer further comprises a first transducer that generates the acoustic wave and a second transducer that produces the signal.

3. The apparatus of claim 1 wherein the at least one transducer is disposed in a cavity on the logging tool, the cavity containing a first fluid.

4. The apparatus of claim 1 wherein the processor estimates the acoustic impedance of the formation by further using a first dereverberation filter.

5. The apparatus of claim 4 wherein a parameter of the first dereverberation filter is determined by at least one of (i) a thickness of the plate, (ii) an acoustic velocity of the plate, (iii) a density of the plate, (iv) a density of a fluid in a cavity on the logging tool, (v) an acoustic velocity of a fluid in a cavity on the logging tool, (vi) a density of a fluid in an annulus between the logging tool and the borehole wall, and (vii) an acoustic velocity of a fluid in an annulus between the logging tool and the borehole wall.

6. The apparatus of claim 5 further comprising at least one device which measures at least one of (i) the acoustic velocity of the fluid in the annulus, and (ii) the density of the fluid in the annulus.

7. The apparatus of claim 4 wherein the processor estimates the acoustic impedance of the formation by further applying a second dereverberation filter, a parameter of the second dereverberation filter being based on a standoff of the logging tool from the wall of the borehole, the apparatus further comprising a caliper device which provides a measurement of the standoff.

8. The apparatus of claim 4 wherein the processor estimates the acoustic impedance of the formation by further applying a deconvolution filter, the deconvolution filter being determined from the acoustic wave generated by the at least one transducer.

9. The apparatus of claim 1 wherein the processor further estimates at least one of (i) an acoustic velocity of the formation, and (ii) a density of the formation from the estimated acoustic impedance using an empirical relation between density and velocity.

10. The apparatus of claim 1 further comprising a sonic logging tool which produces an output indicative of an acoustic velocity of the formation, and wherein the processor further estimates a density of the formation using the output of the sonic logging tool and the estimated acoustic impedance.

11. The apparatus of claim 1 further comprising a conveyance device which conveys the logging tool into the borehole, the conveyance device selected from (i) a drilling tubular, (ii) a wireline, and (iii) a slickline.

12. The apparatus of claim 1 wherein the processor further produces at least one of (i) a density image of the formation, (ii) an impedance image of the formation, and (iii) a velocity image of the formation.

13. The apparatus of claim 1 wherein the property is at least one of (i) a density of the formation, and (ii) an acoustic velocity of the formation.

14. A method of evaluating an earth formation, the method comprising:
(a) conveying a logging tool conveyed into a borehole in the earth formation;
(b) generating an acoustic wave which propagates through a plate on the logging tool to a wall of the borehole;
(c) producing a signal responsive to a reflection of the acoustic wave from the wall of the borehole; and
(d) estimating from the signal an acoustic impedance of the formation.

15. The method of claim 14 estimating the acoustic impedance further comprises using a first dereverberation filter.

16. The method of claim 15 further comprising selecting a parameter of the first dereverberation filter is based on at least one of (i) a thickness of the plate, (ii) an acoustic velocity of the plate, (iii) a density of the plate, (iv) a density of a fluid in a cavity on the logging tool, (v) an acoustic velocity of a fluid in a cavity on the logging tool, (vi) a density of a fluid in an annulus between the logging tool and the borehole wall, and (vii) an acoustic velocity of a fluid in an annulus between the logging tool and the borehole wall.

17. The method of claim 16 further comprising measuring at least one of (i) the acoustic velocity of the fluid in the annulus, and (ii) the density of the fluid in the annulus.

18. The method of claim 15 further comprising estimating the acoustic impedance of the formation by further applying a second dereverberation filter, a parameter of the second dereverberation filter being based on a standoff of the logging tool from the wall of the borehole, the method further comprising providing a measurement of the standoff.

19. The method of claim 15 further comprising estimating the acoustic impedance of the formation by further applying a deconvolution filter, the deconvolution filter being determined from the acoustic wave generated by the at least one transducer.

20. The method of claim 14 further comprising estimating at least one of (i) an acoustic velocity of the formation, and (ii) a density of the formation from the estimated acoustic impedance using an empirical relation between density and velocity.

21. The method of claim 14 further comprising:
(i) making a measurement indicative of an acoustic velocity of the formation,
and
(ii) estimating a density of the formation using the measurement of the acoustic velocity of the formation and the estimated acoustic impedance of the formation.

22. The method of claim 14 further comprising producing at least one of (i) a density image of the formation, (ii) an impedance image of the formation, and (iii) a velocity image of the formation.

23. A computer readable medium for use with an apparatus evaluating an earth formation, the apparatus comprising:
(a) a logging tool conveyed in a borehole in the earth formation;
(b) at least one transducer on the logging tool which:
(A) generates an acoustic wave which propagates through a plate on the logging tool to a wall of the borehole; and
(B) produces a signal responsive to a reflection of the acoustic wave from the wall of the borehole;
the medium comprising instruction which enable a processor to
(c) estimate from the signal an acoustic impedance of the formation.

24. The apparatus of claim 23 further comprising at least one of (i) a ROM, (ii) an EPROM, (iii) an EAROM, (iv) a flash memory, and (v) an optical disk.
